(19) United States
(12) Patent Application Publication
(10) Pub. No.: US 2021/0394854 A1
(43) Pub. Date: Dec. 23, 2021

(54) POWER DEVICE OF MOTORBIKE FOR ENGINE IGNITION

(71) Applicant: Teh-Tang Huang, Tainan (TW)

(72) Inventor: Teh-Tang Huang, Tainan (TW)

(73) Assignee: Teh-Tang Huang, Tainan (TW)

(21) Appl. No.: 16/946,382

(22) Filed: Jun. 19, 2020

(51) Int. Cl. B62J 45/00; F02N 11/08

(52) U.S. Cl. CPC B62J 45/00; F02N 11/0803

(57) ABSTRACT

A power device of motorbikes includes a generator, a step down transformer and a voltage regulator. The generator is driven by output of the engine and generates alternating current which is input to the rectifier, and the rectifier outputs direct current. The rectifier includes a first output portion and a second output portion. The first output portion is electrically connected to a battery of a motorbike, and the second output portion includes a capacitor. The step down transformer is electrically connected to the first output portion. The output of the step down transformer is electrically connected to the battery. The second output portion outputs a voltage greater than that of the battery. The regulator is electrically connected to the rectifier and the battery. When the battery is fully charged, the rectifier stops outputting to the battery. The present invention provides two different output voltages to ignite the engine.

### BACKGROUND OF THE INVENTION

### 1. Fields of the Invention

The present invention relates to a power device of a motorbike, and more particularly, to a power device for providing two different high voltage outputs to ignite the engine.

### 2. Descriptions of Related Art

The output of a motorbike engine is transferred into electric power which is transferred to a voltage regulator. The voltage regulator generates stable charging voltage to charge the motorbike battery. The battery voltage provides necessary electric power to different parts of the motorbike.

As shown in FIGS. 2 and 3, the circuit of current rectify and voltage regulation is disclosed, and comprises a generator 1′, a rectifier 2′, a voltage regulator 3′ and a battery 4′. The generator 1′ is driven by output of the engine and generates alternating current. The alternating current of the generator 1′ is input into the rectifier 2′ and the rectifier 2′ outputs direct current voltage. The voltage regulator 3′ controls the output voltage of the rectifier 2′, and is electrically connected to the battery 4′. The voltage regulator 3′ includes a voltage control circuit 31′ to detect the voltage of the battery 4′. When the battery 4′ is fully charged, the voltage control circuit 31′ controls the rectifier 2′ not to deliver voltage to the battery 4′ so as to prevent the battery 4′ from being changed.

The rectifier 2′ includes a bridge rectifier circuit, and the voltage regulator 3′ includes silicon controlled rectifiers (SCR1, SCR2) which are respectively connected to the positive and negative half phases of the generator 1′ and the rectifier 2′. A transistor Q1 and a Zener diode D1 are respectively and electrically connected to the battery 4′. The Zener diode D1is located corresponding to the saturate voltage 14.5V of the battery 4′. The transistor Q1 is connected the gates of the SCR1 and SCR2.

When the voltage of the battery 4′ is less than 14.5V, the Zener diode D1 is not activated. The rectifier 2′ continuously charges the battery 4′. When the voltage of the battery 4′ reaches 14.5V, the Zener diode D1 is activated. The transistor Q1 electrically connects the SCR1 and SCR2. The rectifier 2′ is grounded and does not charge the battery 4′.

The voltage regulator can only provide an output voltage to the battery 4′, however, the output voltage that is send to ignite the engine may be slightly too low and cannot provide sufficient ignition sparks to ignite the engine, especially when igniting the engine, the battery voltage will drop.

The present invention intends to provide a power device for generating two different output high voltages to easily ignite the motorbike engine, so as to eliminate the shortcomings mentioned above.

### SUMMARY OF THE INVENTION

The present invention relates to a power device of motorbikes for engine ignition, comprises a generator, a step down transformer and a voltage regulator. The generator is driven by output of the engine and generates alternating current which is input to the rectifier, and the rectifier outputs direct current. The rectifier includes a first output portion and a second output portion. The first output portion is electrically connected to a battery of a motorbike, and the second output portion includes a capacitor. The step down transformer is electrically connected to the first output portion. The output of the step down transformer is electrically connected to the battery. The second output portion delivers a voltage greater than that of the battery. The regulator is electrically connected to the rectifier and the battery. When the regulator senses the battery being fully charged, the rectifier stops outputting to the battery. The present invention provides two different voltage outputs to ignite the engine.

Preferably, the step down transformer includes at least one diode which is located in the first output portion so as to the current in the second output portion is greater than the current in the first output portion

Preferably, the rectifier includes a bridge rectifier circuit, and the voltage regulator includes silicon controlled rectifiers SCRs which are respectively connected to the positive and negative half phases of the generator and the rectifier. The voltage regulator includes a voltage control circuit which is electrically connected to the battery and the two respective gates of the two SCRs.

The step down transformer of the present invention drops the voltage so that the rectifier outputs the voltage that is greater than the voltage of the fully charged battery, so that the battery is charged by the first output portion and the dropped voltage from the step down transformer. The second output portion outputs voltage that is not dropped to ignite the engine or to be used by other electric parts.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the circuit of the power device of the present invention;

FIG. 2 shows the conventional power device for motorbike, and

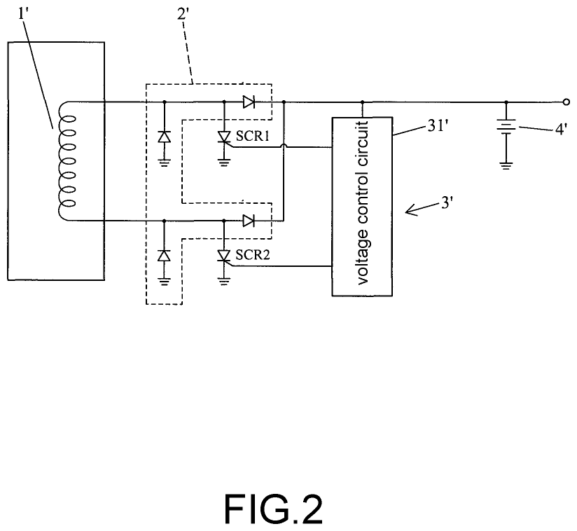

FIG. 3 shows the conventional voltage regulator and the conventional power device for motorbike.

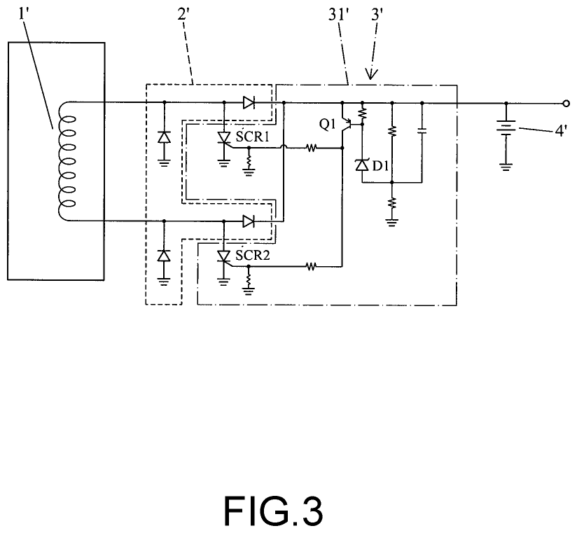

### DETAILED DESCRIPTION OF THE INVENTION

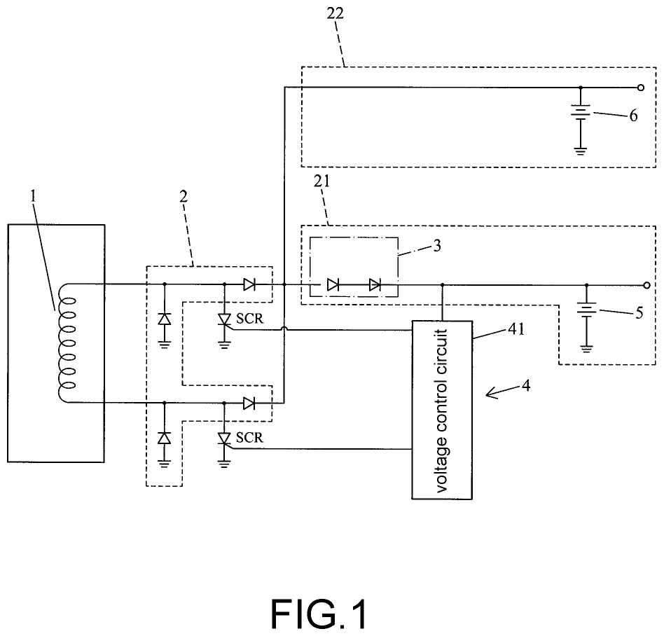

Referring to FIG. 1, the power device of a motorbike of the present invention comprises a generator 1, a rectifier 2, a step down transformer 3 and a voltage regulator 4. The generator 1 is driven by output from the engine of the motorbike (not shown) and generates alternating current.

The alternating current is input to a rectifier 2 from the generator 1, and the rectifier 2 outputs direct current. The rectifier 2 includes a first output portion 21 and a second output portion 22, wherein the first output portion 21 is electrically connected to a battery 5, and the second output portion 22 includes a capacitor 6.

The step down transformer 3 is electrically connected to the first output portion 21. The output of the step down transformer 3 is electrically connected to the battery 5.

The voltage regulator 4 is electrically connected to the rectifier 2 and the battery 5. The voltage regulator 4 includes a voltage control circuit 41 to detect the voltage of the battery 5. When the regulator 4 senses the battery 5 being fully charged, the rectifier 2 stops outputting to the battery 5.

The step down transformer 3 includes two diodes which are s located in the first output portion 21. The rectifier 2 includes a bridge rectifier circuit. The voltage regulator 4 includes silicon controlled rectifiers SCRs which are respectively connected to the positive and negative half phases of the generator 1 and the rectifier 2.

The voltage regulator 4 includes the voltage control circuit which is electrically connected to the battery 5 and the two respective gates of the two SCRs.

When in use, the voltage for the fully charged battery 5 is 14.5V. The battery 5 provides the electric parts (not shown) of the motorbike. The diodes of the step down transformer 3 can accept current of 25A and the voltage is about 1.1V. Therefore, the step down transformer 3 can drop the voltage to 2.2V. The output voltage of the rectifier 2 charges the battery 5 by the first output portion 21 and the dropped voltage by the step down transformer 3. When the voltage control circuit 41 of the voltage regulator 4 detects that the battery 5 is not fully charged to 14.5V, the rectifier 2 continuously charges the battery 5. The voltage of each of the first and second output portions 21, 22 is the sum of the voltage of the battery 5 and the voltage of the step down transformer 3. Therefore, when the battery 5 approaches the fully charged value, the voltage of the second output portion 22 is about 16.7V.

The second output portion 22 outputs a higher voltage that is used by the electric parts such as the engine ignition system of the motorbike (not shown). The spark plug generates strong sparks by higher voltage so as to increase the ignition efficiency.

While we have shown and described the embodiment in accordance with the present invention, it should be clear to those skilled in the art that further embodiments may be made without departing from the scope of the present invention.

What is claimed is:

1. A power device of motorbikes, comprising:
a generator being driven by output of an engine and generating alternating current, the alternating current is input to a rectifier, the rectifier outputting direct current, the rectifier including a first output portion and a second output portion, the first output portion electrically connected to a battery, the second output portion including a capacitor;
a step down transformer electrically connected to the first output portion, an output of the step down transformer electrically connected to the battery, the second output portion outputting a voltage greater than that of the battery when the rectifier outputs, and
a voltage regulator electrically connected to the rectifier and the battery, when the battery is fully charged, the rectifier stops outputting to the battery.

2. The power device as claimed in claim 1, wherein the step down transformer includes at least one diode which is located in the first output portion.
